(19) United States
(12) Patent Application Publication
(10) Pub. No.: US 2003/0107021 A1
(43) Pub. Date: Jun. 12, 2003

(54) Normally closed on-off valve for ultra-high-pressure applications

(76) Inventors: Albert C. Saurwein, Granger, WA (US); Betty L. Boone-Saurwein, Granger, WA (US)

Correspondence Address: STRATTON BALLEW, 213 S 12TH AVE, YAKIMA, WA, 98902, US

(21) Appl. No.: 10/295,218

(22) Filed: Nov. 15, 2002

Related U.S. Application Data
(60) Provisional application No. 60/333,821, filed on Nov. 16, 2001.

(51) Int. Cl. F16K 1/00

(52) U.S. Cl. 251/360

(57) ABSTRACT

A normally closed, two-way ultra-high-pressure valve is comprised of a stem protruding beyond the outer surface of a valve body and extending inwardly toward and coaxially through a stationary seat therein, which separates the high-pressure inlet fluid from the low pressure outlet port, the stem beyond the seat enlarging to a diameter significantly greater than the through-hole. The conical surface is forced back against the hole in the seat by inlet fluid pressure creating the valve seal. External force exerted on the aforementioned protruding stem at the opposite end of the body separates the conical surface away from the seat thus opening the valve.

### PRIORITY CLAIM

This application claims priority under U.S. Provisional Application No. 60/333,821 filed Nov. 16, 2001.

### FIELD OF THE INVENTION

This invention pertains primarily to high-pressure water-jet cutting devices for controlling high-pressure water flow to the cutting nozzle, but is also applicable to any high-pressure two-way valve application within its allowable pressure-temperature limitations.

### BACKGROUND OF THE INVENTION

High-pressure flow to a water-jet cutting nozzle, or any other device to which high-pressure fluid must be supplied (20,000 psi to 60,000 psi) is conventionally controlled by a high-pressure two-way valve, actuated by an air or hydraulic cylinder or a toggle handle. Actuators for control valves used in water-jet cutting, without exception, are integrated into the structural configuration of the valve body. Also, without exception, the high-pressure two-way valves proposed by the prior art of the hydraulic or air-actuated design described above, operate with the conical sealing end of the stem loaded compressively into the bore of the seat by spring means. Application of air or hydraulic pressure acts on the piston-cylinder system at the other end of the stem against the pre-load to retract the stem from the sealing position on the valve seat, thus allowing the flow from the pressurized chamber upstream to flow downstream past the end of the stem and through the seat. To close the valve, the spring force then returns the stem to the sealing position in the seat when the actuation pressure is released. However, this pre-load force must be sufficient in this phase of the operation to return the stem against the pressure force resulting from the pressure acting on the profile area of the stem plus the frictional force exerted by the pressurized seal on the stem. Working with pressures in the ultra-high-pressure range, these forces are very high, requiring a valve body with compatible structural integrity and actuator capability.

This aforementioned conventional design for the two-way ultra-high-pressure on-off valve is thus necessarily large, both to accommodate the high loads and to integrate the piston-cylinder actuation means, and consequently expensive to build.

To simplify the design and reduce the size and manufacturing cost of this valve, the stem-actuator arrangement of this invention is reversed such that the actuator opens the valve by pushing the stem away from the seat against the upstream pressure force on the stem, and the stem returns to the sealing position by the pressure force of the upstream water supply acting on the profile area of the stem. There is thus no need for a pre-load, the higher the upstream pressure the greater the sealing force. A spring system becomes unnecessary, and a choice of inexpensive, commercially available actuators is now available, chosen as a function of available pressure and/or available actuation means; i.e., air or hydraulic, by simply attaching the appropriate actuator to the adapter means on the valve body.

### SUMMARY OF THE INVENTION

This invention provides on-off control in an ultra-high-pressure fluid circuit with a relatively simple and inexpensive valve mechanism.

The stem of this normally closed ultra-high-pressure valve passes through the bore of the seat and enlarges conically to a diameter larger than the seat bore diameter such that external actuation force on the opposite end of the stem pushes the conically shaped sealing stem surface away from the sealing edge of the seat bore to open. When the actuation means is relaxed, the upstream pressure force on the conical end of the stem returns the stem to sealing contact with the seat.

The stem outwardly extending from the seat passes immediately through the outlet cavity with passage to the outlet port, through the stem guide, high-pressure dynamic seal, back-up ring and retaining plug, outside the surface of the valve body to the contact point with the stem actuator.

The remote actuator is a separate component, commercially available, bolted to the opposite sides of the body through adapter blocks. The toggle actuator is fastened to the body by the same means and rotates through an arc, typically approximately 90 degrees, to fully open or close the valve.

The high-pressure port is on the top surface of the valve body with fluid passage into the interior cavity containing the conical end of the stem. This interior cavity is the inner end of a counterbore the outer end of which is a threaded port, the centerline of which is the extended axis of the stem past the conical end. A plug screwed into this threaded port seals the high-pressure cavity and fluid passage from the inlet port.

In an embodiment, the valve body has two threaded holes spaced apart, in from the lower edge, by which to mount the assembly.

### BRIEF DESCRIPTION OF THE DRAWINGS

Two figures are included in this application.

FIG. 1 shows a section through the center of the body-stem assembly, and

FIG. 2 shows a two-times size section through the stem-seal system showing both interior chambers, the plug seal and the stem constraining components at the actuator end.

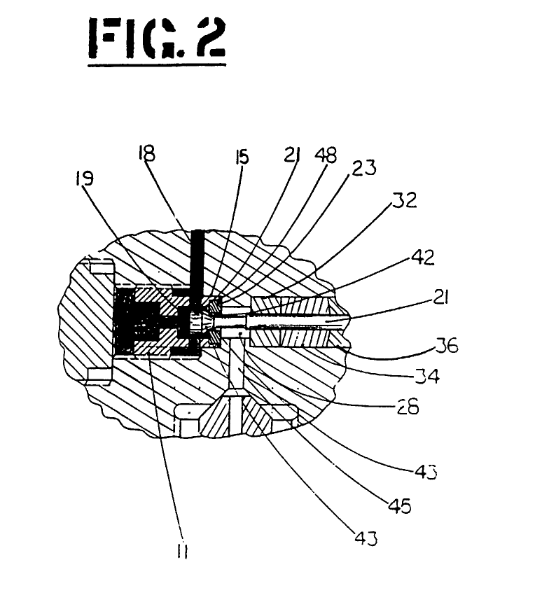

### DETAILED DESCRIPTION OF THE INVENTION

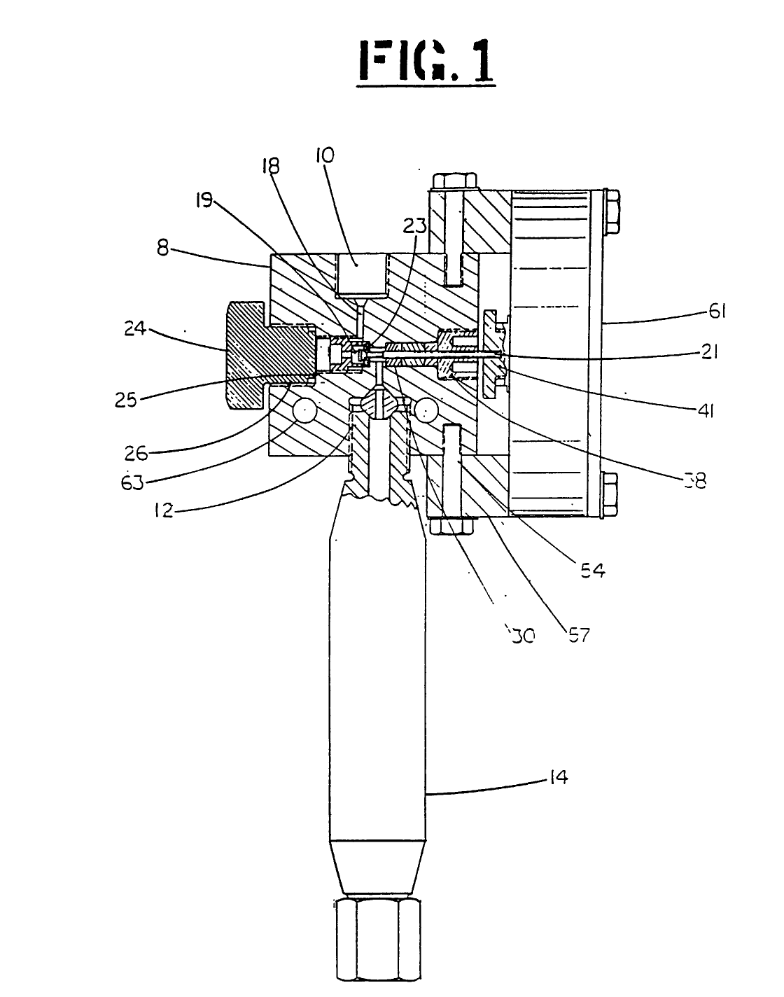

The ultra-high pressure on-off valve of this invention is designed with a standard inlet high-pressure port 10, on one side of the body 8, and on the opposite side is the outlet port 12. The outlet port can be adapted to receive a water-jet cutting nozzle 14 as shown in FIG. 1, or can supply down-stream high-pressure water to some other device.

The high-pressure inlet water passes through the drilled passage 18, and into the interior chamber 19, in the body 8, blocked from the outlet port 12, by the stem 21, which is loaded into sealing communication with the seat 23, by pressure-force on the stem profile, and sealed from leakage around the plug 24, by sealing pressure on the annular surface 25, produced by the force generated as said plug 24, is torqued into the port 26.

The stem 21, is situated concentrically with respect to the bore of the seal seat 23, and extends away from said pressurized chamber. The sealing end of the stem is conically tapered from a diameter at the outer end significantly larger than the orifice diameter of the seat 23 to a smaller diameter concentrically situated within the seat orifice. The resulting annular area is sufficient to produce a minimal pressure drop through said annular area at rated flow conditions, said flow commencing with translation of said conical stem surface away from sealing contact with said seat. The stem passes through a second interior chamber 28 which is in fluid communication with the outlet port 12, through passage 45, and further through a stabilizing ring 32, a high-pressure dynamic seal 34, a high-pressure back-up ring 36, and out through the threaded retaining plug 38. The stem 21, protrudes beyond the said plug 38, outside the perimeter of the body 8, and seats in a counterbore within a plug 41, threaded into the end of the actuator 61, linear actuation thereof resulting in a shift of the stem 21, forcing the concentric conical sealing surface 43, at the other end of said stem 21 away from said seat 23 allowing fluid to pass from said pressurized chamber 19, through the annular area 42, between the stem exterior and the seat interior and into the adjacent interior chamber 28, and through the drilled passage 45, to the outlet port 12. The fluid then passes into the water-jet cutting nozzle 14, or alternatively, continues downstream to supply high pressure water to some other device.

The force required to open the valve is the pressure force resulting from upstream pressure acting on the area of the orifice defined by the high-pressure seat 23. Force available to close the valve is the pressure force resulting from the system pressure acting on the area of the stem 21, at the dynamic seal 34 which must exceed the pressurized frictional force acting on the stem 21 by the dynamic seal 34.

The high-pressure seat 23, is contained in a counterbore 48, in the end of a threaded plug 11, said plug end also snugly contained in a counter bore 15, in the body 8, this arrangement insuring containment and concentricity of the seal seat 23, and ease of removal of said seat 23 for repair or replacement. This arrangement also provides for pre-load of the seat 23, against the face of the counter bore 15, in the body 8, providing the static seal between the two internal chambers 19 and 28.

Preferably, tapped holes 54, on opposite sides of the body 8, at the actuator end of the body 8, provide fastening means for attached blocks 57, or brackets on which to mount the selected actuator 61. The actuator 61, shown in FIG. 1 is an air cylinder with a very short stroke, but a small hydraulic actuator or toggle handle mechanism can equally well be adapted.

A pair of through-holes 63, at the outlet side of the body 8, provides mounting means for said body 8 to a bracket or other appropriate moving or stationary surface or member.

What is claimed is:

1. An on-off valve for an ultra-high pressure water jet system, substantially as shown and described herein.
